(19) United States
(12) Patent Application Publication
(10) Pub. No.: US 2017/0262310 A1
(43) Pub. Date: Sep. 14, 2017

(54) METHOD FOR EXECUTING AND MANAGING DISTRIBUTED PROCESSING, AND CONTROL APPARATUS

(71) Applicant: FUJITSU LIMITED, Kawasaki-shi (JP)

(72) Inventors: Nobuyuki KUROMATSU, Kawasaki (JP); Emeric Viel, Yokohama (JP); Haruyasu Ueda, Ichikawa (JP)

(73) Assignee: FUJITSU LIMITED, Kawasaki-shi (JP)

(21) Appl. No.: 15/452,059

(22) Filed: Mar. 7, 2017

(30) Foreign Application Priority Data
Mar. 9, 2016 (JP) 2016-046241

(51) Int. Cl. G06F 9/48; G06N 99/00

(52) U.S. Cl. CPC G06F 9/4843; G06N 99/005

(57) ABSTRACT

A non-transitory computer-readable recording medium stores a control program that causes a computer to execute a process, the process includes collecting a processing result of a subjob distributed to a plurality of nodes, each of the plurality of nodes processing a to-be-processed job distributed among the nodes estimating an overall processing result, based on the collected processing results of the subjobs, the overall processing result being a result of overall processing corresponding to the subjobs; and determining whether or not to continue processing remaining subjobs of the subjobs corresponding to the overall processing depending on the estimated overall processing result.

### CROSS-REFERENCE TO RELATED APPLICATIONS

This application is based upon and claims the benefit of priority of the prior Japanese Patent Application No. 2016-046241, filed on Mar. 9, 2016, the entire contents of which are incorporated herein by reference.

### FIELD

The embodiments discussed herein are related to computer-readable recording media, methods for executing and managing distributed processing, and apparatuses for executing and managing distributed processing.

### BACKGROUND

Machine learning or big data has become a focus of attention in recent years. Processing for such machine learning on big data may be accelerated by distributing processing among a plurality of servers. Software, e.g., Apache (registered trademark) Spark (hereinafter, “Spark”), that implements high-speed in-memory processing may be used in such distributed processing across a plurality of servers.
Patent Document 1: Japanese Laid-open Patent Publication No. 2013-022558
Patent Document 2: Japanese Laid-open Patent Publication 2013-073301

Machine learning has two phases: a learning phase and a prediction phase. At the learning phase, a predictive model is output from input of data. At the prediction phase, prediction is made based on the predictive model output at the learning phase and input data. Prediction accuracy, i.e., a prediction result, of the predictive model matters in machine learning. For this reason, in machine learning, to increase prediction accuracy of the predictive model, building a predictive model using a different one, each time, of combinations of two or more changeable various processing parameters and making a prediction are repeatedly performed, thereby determining a processing parameter combination that increases the prediction accuracy. In machine learning, the larger the number of the processing parameter combinations to be searched, the more preferable for obtaining a predictive model achieving a high prediction accuracy.

There can be a case where a limit is imposed on the length of time usable on distributed processing. For example, there can be a case where start time for using a predictive model is determined in advance and a time limit is imposed on distributed processing. In this case, a predictive model that achieves the highest prediction accuracy among predictive models obtained until the time limit is up may preferably be determined. In machine learning, prediction accuracy of a predictive model increases with the number of processing parameter combinations searched within time limit. For this reason, when machine learning is processed distributed on a plurality of servers, prediction accuracy is affected by processing efficiency of distributed processing. When an optimization problem, such as machine learning, is processed by distributed processing, distributed subjobs can include a subjob that does not affect final prediction accuracy significantly. To increase processing efficiency of distributed processing, it is desirable that it is possible to abort such a subjob that does not affect prediction accuracy significantly.

However, conventional distributed processing frameworks, such as Spark, do not manage each processing result of distributed processing that is in progress. Furthermore, conventional distributed processing frameworks are disadvantageous in that, making determination as to whether to abort processing decreases the speed of parallel processing rather than increasing the speed, resulting in a decrease in processing efficiency of distributed processing.

A problem has been described above through the example of distributed processing for machine learning. However, such a problem can arise in any distributed processing using a conventional distributed processing framework.

### SUMMARY

According to an aspect of an embodiment, a non-transitory computer-readable recording medium stores a control program that causes a computer to execute a process, the process includes collecting a processing result of a subjob distributed to a plurality of nodes, each of the plurality of nodes processing a to-be-processed job distributed among the nodes; estimating an overall processing result, based on the collected processing results of the subjobs, the overall processing result being a result of overall processing corresponding to the subjobs; and determining whether or not to continue processing remaining subjobs of the subjobs corresponding to the overall processing depending on the estimated overall processing result.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example architectural overview of a distributed processing system;

FIG. 2 is a diagram illustrating an example of an software architectural overview of a master unit and worker units;

FIG. 3A and FIG. 3B are diagrams each schematically illustrating an overview of a workflow of machine learning;

FIG. 4 is a diagram schematically illustrating an example of conventional distributed processing for machine learning using Spark;

FIG. 5 is a diagram schematically illustrating an example of distributed processing for machine learning according to an embodiment;

FIG. 6 is a diagram schematically illustrating art overview of a workflow of machine learning performed by a distributed processing system according to the embodiment;

FIG. 7 is a diagram schematically illustrating an overview of a workflow of predictive model validation by K-cross-validation;

FIG. 8A and FIG. 8B are diagrams each schematically illustrating a job flow of a predictive-model validation job;

FIG. 9 are diagrams each schematically illustrating an overview of a workflow of machine learning;

FIG. 10 is a flowchart illustrating an example of a procedure for distributed processing;

FIG. 11 is a flowchart illustrating an example of a procedure for a validation process;

FIG. 12 is a flowchart illustrating an example of a procedure for a predictive-model validation process;

FIG. 13 is a flowchart illustrating an example of a procedure for a management process; and

FIG. 14 is an explanatory diagram illustrating an example architecture of a computer that executes a distributed-processing execution-and-management program.

### DESCRIPTION OF EMBODIMENTS

Preferred embodiments of the present invention will be explained with reference to accompanying drawings. Note that the embodiments are not intended to limit the scope of the invention. The embodiments can be combined as appropriate so long as no contradiction arises in processing.

### First Embodiment

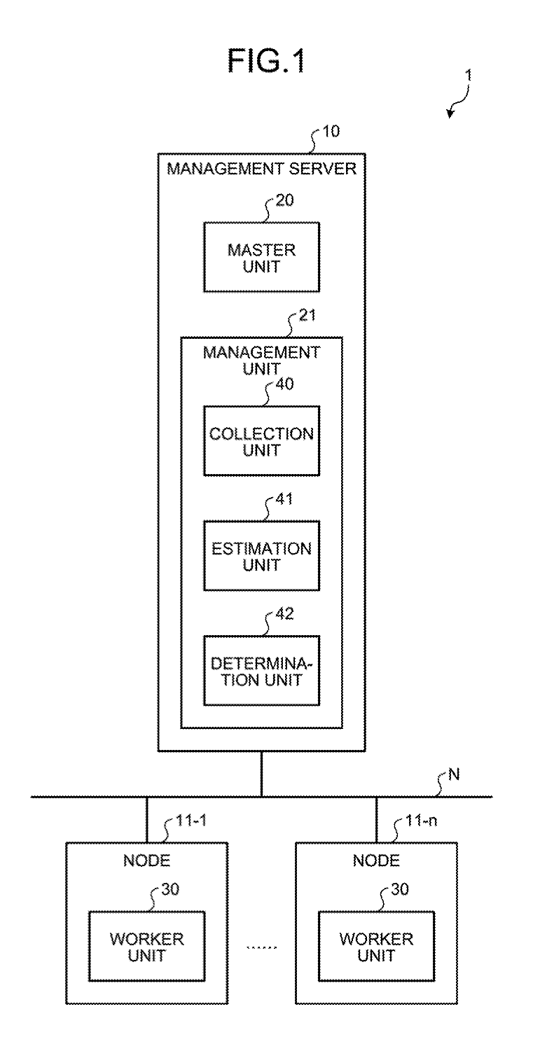

A distributed processing system according to a first embodiment is described below. FIG. 1 is a diagram illustrating an example architectural overview of the distributed processing system.

A distributed processing system 1 includes a management server 10 and a plurality of nodes 11-1, . . . , and 11-n (n is a given natural number). The plurality of nodes 11-1, . . . and 11-n are collectively referred to as “the nodes 11”. The management server 10 and the nodes 11 are communicably connected via a network N. The network N may be embodied as an arbitrary network, which may be either a wired or wireless network, such as a LAN (Local Area Network) and a VPN (Virtual Private Network).

The management server 10 is an apparatus that manages distributed processing. The management server 10 may be a computer, such as a personal computer and a server computer, for example. The management server 10 may foe implemented as a single computer or, alternatively, may be implemented as a plurality of computers. Further alternatively, the management server 10 may be a virtual machine, which is an emulation of a computer. The first embodiment is described through an example where the management server 10 is implemented as a single computer. Although not illustrated in the example of FIG. 1 that illustrates a functional architecture, the management server 10 includes a variety of hardware pieces that make up the computer. For example, the management server 10 includes a storage unit, such as an HDD (Hard Disk Drive) and an SSD (Solid State Drive), a memory, such as a RAM (Random Access Memory), and a control unit, such as a CPU (Central Processing Unit), that controls the apparatus. Various program instructions (hereinafter, “programs”) stored in the storage unit operate on the control unit, thereby causing the management server 10 to function as various processing units. The management server 10 includes a master unit 20 and a management unit 21.

The master unit 20 manages distributed processing. For example, the master unit 20 that manages overall information about distributed processing allocates tasks of distributed processing to the nodes 11 and instructs the nodes 11 to execute the tasks. The management unit 21 collects processing results of processing executed by the nodes 11 from the nodes 11 and determines whether or not to continue executing distributed processing. The management unit 21 will be described in detail later.

The node 11 is an apparatus that executes an allocated part of distributed processing. The node 11 may be a computer, such as a personal computer and a server computer, for example. The node 11 may also be implemented as a single computer or, alternatively, may be implemented as a plurality of computers. Further alternatively, the node 11 may be a virtual machine, which is an emulation of a computer. The first embodiment is described through an example where each, of the nodes 11 is implemented as a single computer. Although not illustrated in the example of FIG. 1 that illustrates the functional architecture, each of the nodes 11 includes a variety of hardware pieces that make up the computer. For example, each of the nodes 11 includes a storage unit, such as an HDD and an SSD, a memory, such as a RAM, and a control unit, such as a CPU, that controls the apparatus. Various programs stored in the storage unit operate on the control unit, thereby causing the node 11 to function as various processing units. The node 11 includes a worker unit 30.

The worker unit 30 executes distributed processing. For example, the worker unit 30 executes a task, execution of which is instructed, from the master unit 20.

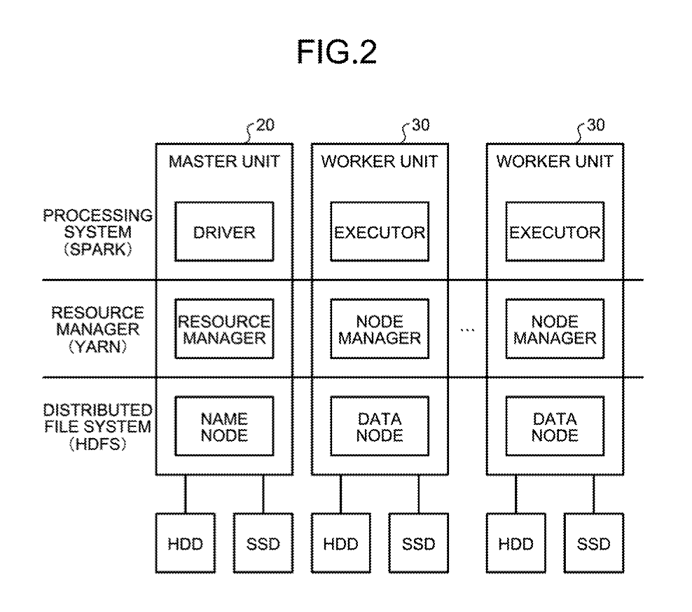

A software architecture of the master unit 20 and the worker unit 30 that implement distributed processing is described below. FIG. 2 is a diagram illustrating an example of a software architectural overview of the master unit and the worker units. As illustrated in FIG. 2, each of the master unit 20 and the worker units 30 is functionally divided into three layers: a processing system, a resource manager, and a distributed file system.

The distributed file system stores and manages data to be processed by distributed processing. Big data processed by distributed processing is typically a massive amount of data, e.g., terabytes or petabytes. Such big data is typically distributed to storage units, such as HDDs and SSDs, of the management server 10 and the nodes 11 and stored therein. The distributed file system manages data sets distributed to the management, server 10 and the nodes 11 and stored therein as a single, seamless file system, thereby making it possible to perform an operation of accessing and holding the data and files. Examples of the distributed file system include, but not limited to. HDFS (Hadoop (registered trademark) Distributed File System). When HDFS is used, a NameMode operates on the master unit 20. A DataNode operates on the worker unit 30.

The resource manager performs, for each of the nodes 11, allocation management of resources including the CPU, the memory, disk bandwidth, and network bandwidth, and scheduling. Examples of the resource manager include, but not limited to, YARN (Yet Another Resource Negotiator). When YARN is used, a ResourceManager operates on the master unit 20. A NodeManager operates on the worker unit 30.

The processing system executes and manages distributed processing. Examples of the processing system include, but not limited to, Spark. The first embodiment is described through an example where Spark is used as software that executes and manages distributed processing. Note that the technology related to the first embodiment is not specific to Spark but is applicable to mechanisms of general parallel distributed processing. When Spark, is used, a driver operates on the master unit 20. An executer operates on the worker unit 30.

In machine learning, to increase prediction accuracy of a prediction result, building a predictive model and making a prediction using a different one, each time, of combinations of changeable various processing parameters are repeatedly performed, thereby determining a processing parameter combination that increases the prediction accuracy. Examples of the changeable various processing parameters of the predictive model include learning algorithms, hyperparameters for learning algorithm, and libraries for use in learning. In machine learning, a search range for combinations of processing parameters is specified in advance. The search range for the processing parameters may be specified by a user, such as an administrator, or, alternatively, obtained by calculation using a previous learning result(s). In machine learning, learning and prediction are sequentially or simultaneously performed using a different one, each time, of the processing parameter combinations within the specified range, thereby searching for a combination that achieves a higher prediction accuracy. In machine learning, a predictive model that achieves the highest prediction accuracy among prediction accuracies obtained in the search is finally adopted.

Spark implements high-speed in-memory processing. Spark can speed up job iteration, for which MapReduce that has been a de facto standard as a tool for processing big data before the advent of Spark is less suitable. For this reason, Spark is highly suitable for machine learning. Performing machine learning using Spark reduces processing time per trial and increases the number of available trial times as compared with MapReduce.

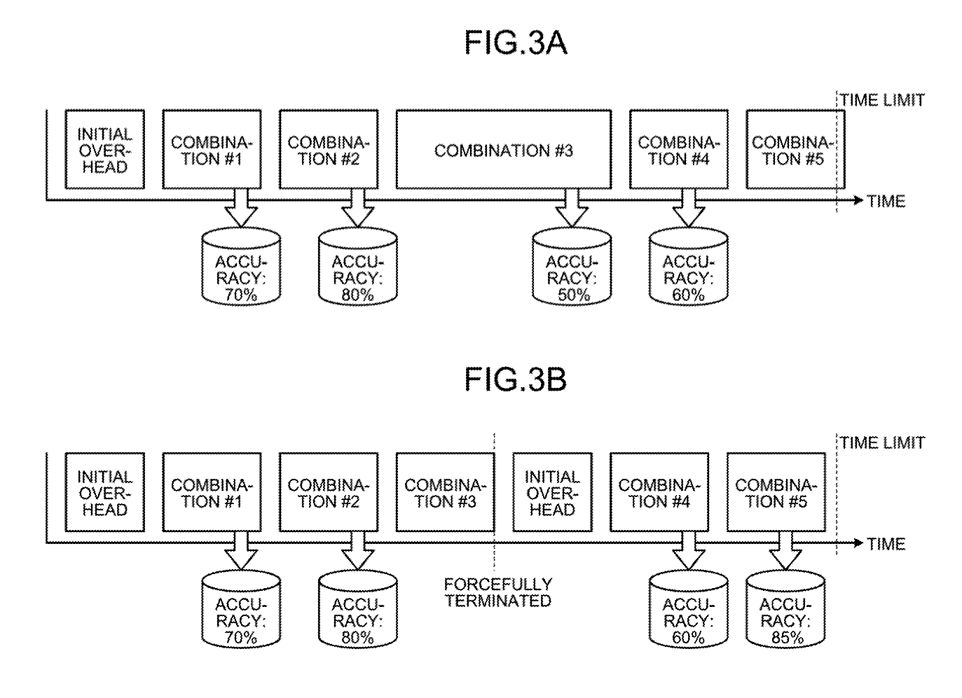

FIG. 3A and FIG. 3B are diagrams each schematically illustrating an overview of a workflow of machine learning. In machine learning, the larger the number of the processing parameter combinations to be searched, the more preferable for obtaining a predictive model achieving a high prediction accuracy. There can be a case where a limit is imposed on the length of time usable on processing in machine learning. For example, in machine learning, there can be a case where start time for using a predictive model is determined in advance. For these reasons, there cars be a case where the number of available trial times is insufficient in spite that processing speed is increased by use of Spark. In this case, in machine learning, a predictive model that achieves the highest prediction accuracy among predictive models obtained before the start time may preferably be determined.

In the examples of FIG. 3A and FIG. 3B, time limit is imposed on the search of a predictive model. In the example of FIG. 3A, a predictive-model search process is executed sequentially from a combination #1 to a combination #5, but time limit is up during when processing for the combination #5 is in progress. Prediction accuracy of a predictive model of the combination #1 is 70%. Prediction accuracy of a predictive model of the combination #2 is 80%. Prediction accuracy of a predictive model of the combination #3 is 50%. Prediction accuracy of a predictive model of the combination #4 is 60%. In the example of FIG. 3A, the predictive model of the combination #2 that achieves the prediction accuracy of 80% is obtained as a predictive model, having the highest prediction accuracy.

When an optimization problem, such as machine learning, is processed by distributed processing, distributed subjobs can include a subjob that does not affect final prediction accuracy significantly. For example, the predictive model of the combination #3 has the low prediction accuracy of 50% and therefore is not selected as the final predictive model. To increase processing efficiency of distributed processing, it is desirable that it is possible to abort such a subjob that does not affect prediction accuracy significantly.

However, a conventional distributed processing framework, such as Spark, does not manage processing results of each of processing parameter combinations when processing is in progress. Furthermore, when determination as to whether to abort processing is made by a conventional distributed processing framework, speed of parallel processing can decrease rather than increase, resulting in a decrease in processing efficiency of distributed processing. For example, when determination as to whether to abort processing is made by a conventional distributed processing framework, and processing on the framework is forcefully terminated, an initial overhead will be spent on executing processing again. In the example of FIG. 3B, a predictive-model search process is sequentially executed from the combination #1, the combination #2, to the combination #3 in order. Processing for the combination #3 is forcefully terminated because it is estimated that a low prediction accuracy will be yielded when processing for the combination #3 is in progress. In this case, a conventional distributed processing framework spends, after forcefully terminating processing for the combination #3, an initial overhead on executing processing for the combination #4. The initial overhead may include, for example, processing of starting parallel processing and processing for avoiding an already-tried combination(s), In the example of FIG. 3B, processing is executed again from the combination #4, and time limit is up after processing for the combination #5 is completed. Prediction accuracy of a predictive model of the combination #1 is 70%. Prediction accuracy of a predictive model of the combination #2 is 80%. Prediction accuracy of a predictive model of the combination #4 is 60%. Prediction accuracy of a predictive model of the combination #5 is 85%. In the example of FIG. 3B, the predictive model of the combination #5 that achieves the prediction accuracy of 85% is obtained as a predictive model having the highest accuracy.

As a contrivance for reducing the initial overhead, for example, a method of storing results as checkpoints at regular intervals and avoiding repeated search processing by using the checkpoint results when executing processing again, can be devised. However, this method is disadvantageous in that processing performed between checkpoints will be executed again. When processing is forcefully terminated, a conventional distributed processing framework will disadvantageously spend an initial overhead on starting parallel processing to execute processing again.

To alleviate the disadvantages, the distributed processing system 1 according to the first embodiment includes the management unit 21 as illustrated in FIG. 1, The distributed processing system 1 according to the first embodiment is configured such that when distributed processing is in progress, the management unit 21 can determine whether or not to continue processing for a certain processing parameter combination, and select and stop a part of distributed processing. The management unit 21 determines, from a result of processing that is in progress, whether to continue processing or carry out a trial with a next processing parameter combination without stopping distributed processing running on the master unit 20 and the worker units 30.

An example of a concrete method is described in detail below. The following description is made through an example where Spark is used as representative software that executes distributed processing. Note that the technology related to the first embodiment is not specific to Spark but is applicable to mechanisms of general parallel distributed processing.

Subcomponents in granularity level, from coarse to fine, in processing by Spark are as follows: application>job>stage>task. At each of the granularity levels, a subcomponent at a higher level is made up of one or a plurality of subcomponents at a lower level. For example, machine learning processing corresponding to an application. Search processing on a per-processing parameter combination basis can be expressed as processing executed by one job or a set of a plurality of jobs. Spark is a master-worker type distributed processing system. The driver included in the master unit 20 instructs the executer included in each of the worker units 30 to execute a task. Each time a job result is output, the driver acquires results from the executers and causes a next job to be executed.

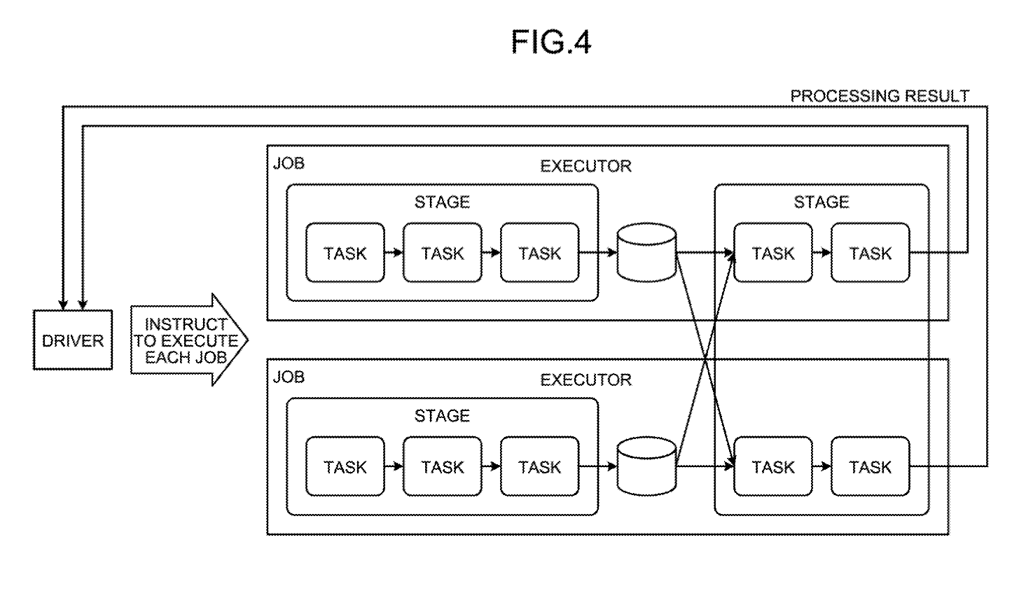

FIG. 4 is a diagram schematically illustrating an example of conventional distributed processing for machine learning using Spark. In distributed processing for machine learning using Spark, a job is split into one or more stages and executed in stages. The job is split into stages at a break between processes that involve data sharing across executors. A stage is made up of one or a plurality of tasks. When all task(s) making up a stage is completed, it is assumed that execution of the stage is completed. In the example of FIG. 4, a model search process for one combination is implemented with three stages (ten tasks). Each executor returns processing results to the driver on a per-job basis rather than on a per-task basis or on a per-stage basis. In distributed processing for machine learning using Spark, the job illustrated in FIG. 4 is repeatedly executed for each of processing parameter combinations.

The driver has a mechanism that causes processing a job to be stopped. For example, the driver has a control, command that stops processing a job that is in progress. However, the driver does not have means for obtaining information about an execution status, such as an in-progress execution result of a job, a task, or a stage that is in progress, when the job is in progress. Therefore, for example, even when the executors have sufficient information in the form of task results or stage results for making determination as to whether to abort a job, the executors return processing results to the driver only on a per-job basis. Hence, because the driver is not fed with information about an execution status when a job is in progress, the driver is unable to determine whether to stop processing when the job is progress.

The reason why the executors return processing results to the driver on a per-job basis, rather than on a per-task basis or on a per-stage basis, in Spark is that returning processing results on a small-processing-unit basis will decrease execution efficiency. In distributed processing using Spark, when a processing result is returned from an executor to a driver, overall control for processing is transferred to the driver. When control for processing has been transferred to the driver, distributed processing on the executor is placed in an idle state. In other words, execution of distributed processing is temporarily stopped. To increase execution efficiency, Spark provides control to the executors on a per-job basis, i.e., at a coarse granularity level.

In machine learning, for example, validation of predictive models using one processing parameter combination is executed as one job. To return information for use in determining whether to stop processing a batch that is in progress to the driver, a need of returning a processing result of a tasks or a stage to the driver arises. In this case, each time processing a task or a stage is completed, control is transferred to the driver. As a result, efficiency of predictive model validation decreases, arising a problem that a total number of combinations that can be validated decreases. For this reason, the executors return processing results to the driver on a per-job basis rather than on a per-task basis or on a per-stage basis.

However, the distributed processing system 1 according to the first embodiment includes, as illustrated in FIG. 1, the management unit 21 in the management server 10 so that whether to stop executing a job that is in progress can be determined without returning control to the driver.

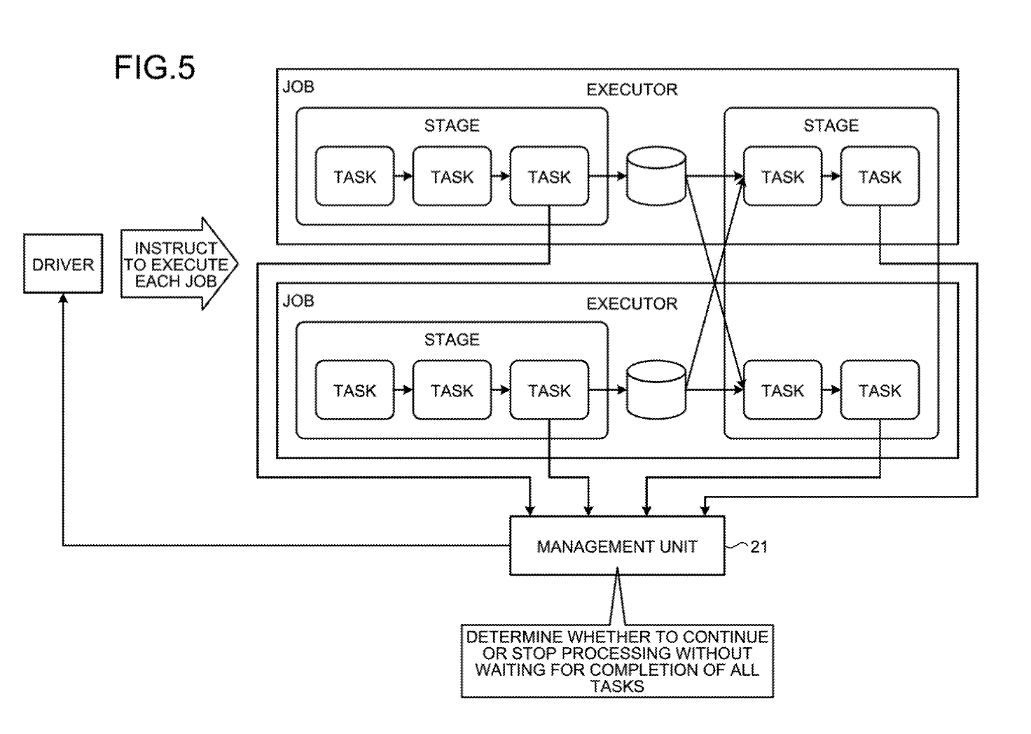

FIG. 5 is a diagram schematically illustrating an example of distributed processing for machine learning according to the first embodiment. The executor of each of the nodes 11 according to the first embodiment transmits, when a processing result of a task, based on which whether to stop or continue processing is to be determined, is obtained, processing result information indicating the processing result to the management unit 21. In the example of FIG. 5, a final task in each or the stages transmits processing result information indicating a processing result to the management unit 21. The management unit 21 determines whether or not to continue executing distributed processing based on the processing result information transmitted from each of the nodes 11. When the management unit 21 determines that it is unnecessary to continue executing distributed processing, the management unit 21 transmits instruction information that instructs to stop processing the job to the driver.

A configuration of the management unit 21 according to the first embodiment is described in more detail below. As illustrated in FIG. 1, the management unit 21 includes a collection unit 40, an estimation unit 41, and a determination unit 42.

The collection unit 40, collects a variety of information. For example, the collect ion unit 40 collects, from each of the plurality of nodes 11 that process a to-be-processed job distributed among the nodes 11, a processing result of a subjob distributed to the node 11. Specifically, for example, the collection unit 40 collects processing results of tasks or stages, each of which is a subjob of a to-be-processed job, from the plurality of nodes 11 that execute the to-be-processed job distributed among the nodes 11. The processing result may be either a processing result processed and held by each of the plurality of nodes 11 or a processing result generated through a process executed across two or more of the plurality of nodes 11. As illustrated in FIG. 5, a stage may be executed by one executor in some cases but, in other cases, may be executed by a plurality of executors. The collection, unit 40 collects processing results, each of which is obtained by processing executed by the executor of each of the nodes, or a processing result obtained by processing executed by the executors of two or more of the plurality of nodes 11.

The estimation unit 41 makes a variety of estimations. For example, the estimation unit 41 estimates, based on the processing results of the subjobs collected by the collection unit 40, an overall processing result, which is a result of overall, processing corresponding to the subjobs. For example, the estimation unit 41 estimates, based on the collected processing results of the subjobs, a prediction accuracy of a predictive model of the job corresponding to the subjobs. For example, the estimation unit 41 calculates a mean value of collected prediction accuracies of subjobs of a job and estimates that the mean value of the prediction accuracies is a predicted accuracy of an overall processing result. The estimation unit 41 may calculate the mean value either upon obtaining one prediction accuracy or upon obtaining a predetermined number of prediction accuracies. The method for predicting the overall processing result is not limited to the mean method. For example, the estimation unit 41 may estimate the overall processing result from the collected processing results of the subjobs using a known predictive model.

The determination unit 42 mates a variety of determinations. For example, the determination on unit 42 determines whether or not to continue processing the remaining subjob(s) of the subjobs corresponding to the overall processing depending on the overall processing result estimated by the estimation unit 41. For example, the determination unit 42 determines that it is unnecessary to process the remaining part of the job when the overall processing result estimated by the estimation unit 41 satisfies a criterion for determining whether to stop the job. The criterion may be either fixed or specified by a user, such as an administrator, in advance or, further alternatively, dynamically determined using a previous processing result(s).

Two conditions are conceivable for the criterion for determining whether to stop a job. A first one is that it is estimated that a performance requirement will be satisfied. The performance requirement may be satisfied when, for example, it is estimated from processing results of subjobs that a predictive model will achieve a satisfactory prediction accuracy. A second one is that it is estimated that a performance requirement will not be satisfied. The performance requirement may fail to be satisfied when, for example, it is estimated from processing results of subjobs that a predictive model will have a low prediction accuracy.

Accordingly, the determination unit 42 determines that it is unnecessary to execute the remaining subjob(s) of the subjobs corresponding to the overall processing when it is estimated that the overall processing result estimated by the estimation unit 41 will satisfy the predetermined performance requirement or will not satisfy the predetermined performance requirement. For example, when a prediction accuracy estimated by the estimation unit 41 satisfies first prediction accuracy or does not satisfy second prediction accuracy, which is lower than the first prediction accuracy, the determination unit 42 determines that it is unnecessary to execute the remaining subjob(s) of a job, for which the prediction accuracy is estimated. For example, the first prediction accuracy can be set to 85%. The second prediction accuracy can be set to 50%. The first prediction accuracy and the second prediction accuracy may be either fixed or specified by a user, such as an administrator, in advance or, further alternatively, dynamically determined using a previous processing result(s). For example, even when an initial value of the first prediction accuracy is set to 85%, when a predictive model having a prediction accuracy higher than 85% is obtained, the first prediction accuracy may be updated to the prediction accuracy of this predictive model. Even when an initial value of the second prediction accuracy is set to 50%, when prediction accuracies of predictive models have been collected, the second prediction accuracy may be updated a value lower than a maximum value of the collected prediction accuracies by a predetermined value (e.g., 15%).

When the determination unit 42 determines that it is unnecessary to execute the remaining subjob(s) of the job, the determination unit 42 transmits instruction information that instructs to stop processing the job to the master unit 20.

Upon receiving the instruction information that instructs to stop processing the job, the driver included in the master unit 20 stops the job, for which the stop instruction is given, and instructs the executors to execute the next job.

In distributed processing of big data, details of the data are generally not known in advance. For this reason, a conventional distributed processing framework is disadvantageous in that an overview remains unknown until all processing is finished. By contrast, the first embodiment can implement efficient processing because the management unit 21 determines, for each of jobs, whether to abort the job using information obtained during when the job is in progress rather than waiting until processing of all data that is to be processed by the job is finished.

The first embodiment has been described through an example where the management unit 21 is provided on the management server 10; however, location of the management unit 21 is not limited thereto. The management unit 21 may operate on any apparatus so long as the management unit 21 can receive execution results from the executors of the nodes 11 and transmit instruction information to the master unit 20 of the management server 10. For example, the management unit 21 may be provided on any one the nodes 11 or, alternatively, on a server other than any one of the management server 10 and the nodes 11. In this case, information indicating the location where the management unit 21 is executed is preferably transmitted to the executor of each of the nodes 11 so that the executor can transmit a processing result to the management limit 21. For example, the master unit 20 may transmit information indicating the operating location of the management unit 21 to the executor of each of the nodes 11 via a command line or a configuration file as static configuration information before startup of Spark. In a case where the operating location of the management unit 21 is fixed and execution results are transmitted from the executor of each of the nodes 11 invariably to the operating location of the management unit 21, it is unnecessary for the master unit 20 to transmit information indicating the operating location of the management unit 21 to the executor of each of the nodes 11.

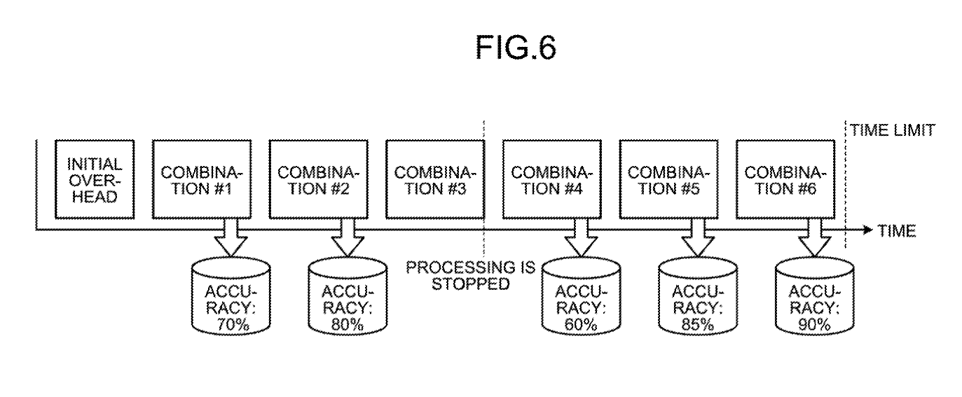

FIG. 6 is a diagram schematically illustrating an overview of a workflow of machine learning performed by the distributed processing system according to the first embodiment. In the example of FIG. 6, time limit is imposed on the search of a predictive model as in FIG. 3A and FIG. 3B. In the example of FIG. 6, a predictive-model search process is sequentially executed from the combination #1 to a combination #6. The executor of each of the nodes 11 transmits, upon obtaining a processing result of a task, based on which whether to stop or continue processing is to be determined, processing result information indicating the processing result to the management unit 21.

When the management Unit 21 determines that a trial result, which is predicted from the transmitted processing result information, for a combination is lower than, a satisfactory prediction accuracy, the management unit 21 transmits instruction information that instructs to stop processing a job to the master unit 20. Upon receiving the instruction, information that instructs to stop processing, the master unit 20 starts a trial with the next combination. In the example of FIG. 6, a predictive-model search process is sequentially executed from the combination #1, next the combination #2, and then, the combination #3. Processing for the combination #3 is stopped because it is estimated that a low prediction accuracy will be yielded when processing for the combination 13 is in progress. In the example of FIG. 6, the predictive-model search process is sequentially executed from the combination #4, next the combination #5, and then the combination #6, and time limit is up after processing for the combination #6 is completed. Prediction accuracy of a predictive model of the combination #1 is 70%. Prediction accuracy of a predictive model of the combination #2 is 80%. Prediction accuracy of a predictive model of the combination #4 is 60%. Prediction accuracy of a predictive model of the combination #5 is 85%. Prediction accuracy of a predictive model of the combination #6 is 90%. In the example of FIG. 6, the predictive model of the combination #6 that achieves the prediction accuracy of 90% is obtained as a predictive model having the highest prediction accuracy.

As described above, in the distributed processing system 1 according to the first embodiment, because control does not return to the driver for making determination as to whether to stop or continue processing, processing efficiency of distributed processing can be increased. Accordingly, the distributed processing system 1 allows increasing the number of the combinations that can be tried within the time limit. Although the method for implementing stopping a job has been described through an example of Spark in the first embodiment, the method is applicable to other similar systems as well.

A concrete example of the method for implementing stopping a job is described below. In distributed processing for machine learning, validation of predictive models is executed as a job for each combination of processing parameters. The predictive model validation is performed by K-cross-validation (K-fold cross validation), whereby a prediction accuracy of predictive models is obtained as a validation result.

In K-cross-validation, data to be processed is split into K split parts to form patterns of training datasets and a validation dataset. For example, in K-cross-validation, a plurality of patterns, each of which includes any one of the K split parts as a validation dataset and the remaining K−1 parts as training datasets, are formed by selecting a different one of the split parts as the validation dataset for each pattern. In the first embodiment, K patterns are formed by selecting a different one of the K split parts as the validation dataset and setting the remaining K−1 parts as the training datasets,

In the predictive model validation, K predictive models are built and validated using the training datasets and the validation dataset of each of the formed K patterns and, by integrating obtained prediction accuracies of the K predictive models, validation for the combination is performed. For the integration, one of a plurality of methods including a mean value and a maximum value can be used.

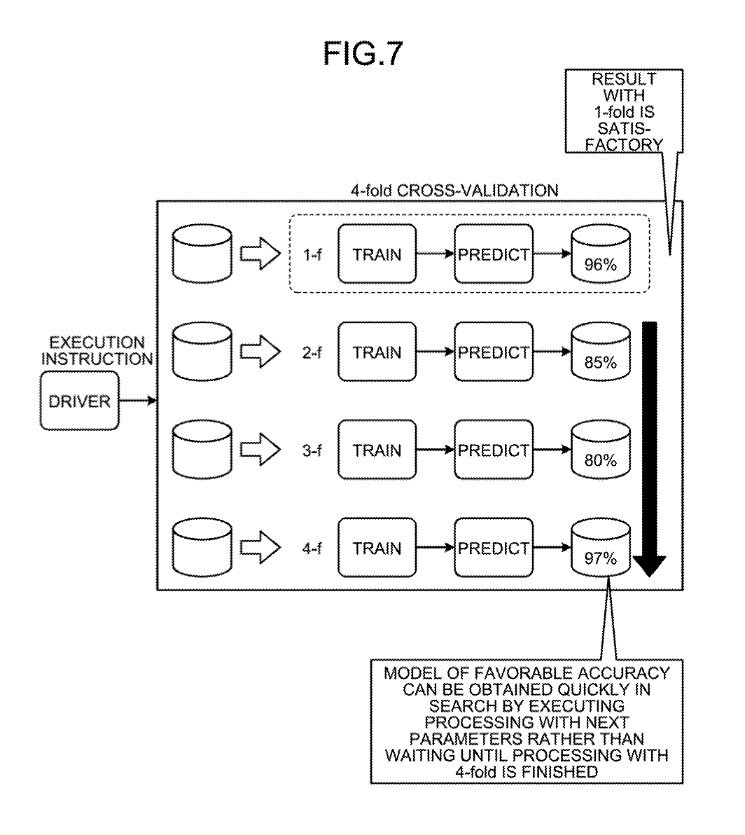

FIG. 7 is a diagram schematically illustrating an overview of a workflow of predictive model validation by K-cross-validation. Description is made with reference to FIG. 7 through an example of K=4 or, put another way, 4-fold-cross-validation. In the predictive model validation illustrated in FIG. 7, predictive models are built (trained) respectively with four patterns (1-f, 2-f, 3-f, and 4-f), which is sequentially followed by validation (prediction). Assume that, for example, during when processing is performed for the patterns 1-f, 2-f, 3-f, and 4-f in this order, processing for the pattern 1-f yields a prediction accuracy that is sufficiently high in machine learning as illustrated in FIG. 7. If, when such a high prediction accuracy is obtained, it is determined that the predictive model has a sufficiently-high prediction accuracy and processing for the patterns 1-f, 3-f, and 4-f is skipped, processing time can be reduced to one quarter.

Assume that, for example, during when processing is performed for the patterns 1-f, 2-f, 3-f and 4-f in this order, processing for the pattern 1-f yields a prediction accuracy of 50%, which is low in machine learning. When such a considerably-low prediction accuracy is obtained, an increase in prediction accuracy is less likely to occur even if time is spent on the remaining part of processing. Therefore, in such a case, processing time for the predictive model validation can be reduced to one quarter if processing for the patterns 2-f, 3-f, and 4-f is skipped.

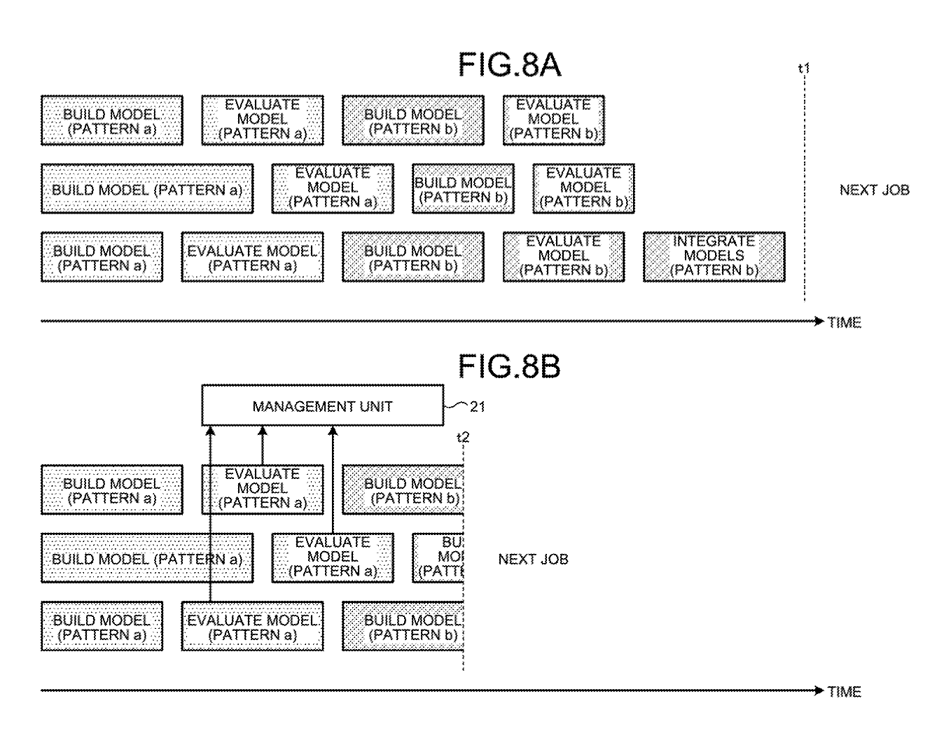

FIG. 8A and FIG. 8B are diagrams each schematically illustrating a job flow of a predictive-model validation job. Description is made with reference to FIG. 8A and FIG. 8B through examples where, in each one job, predictive models are built and validated with two patterns (a and b) sequentially by the three nodes 11 by distributed processing. FIG. 8A illustrates an example where predictive models are built and validated with the patterns a and b sequentially by conventional distributed processing. In FIG. 8A, the next job is started at time t1, at which processing for the patterns a and b is completed.

FIG. 8B illustrates an example where predictive models are built and validated with the patterns a and b sequentially by distributed processing of the first embodiment. Each of the nodes 11 transmits information indicating a prediction accuracy, which is a result of validating the predictive model, as a processing result to the management unit 21. FIG. 8B illustrates an example where the management unit 21 determines that it is unnecessary to execute remaining subjobs of the job from information indicating prediction accuracies with the pattern a transmitted from the nodes 11 and instructs the master unit 20 to stop processing the job. Upon being instructed to stop processing the job, the driver included in the master unit 20 stops the job and instructs the executors to execute the next job. Referring to the example of FIG. 8B, although processing for building a predictive model with the pattern b is already started in some Of the nodes 11, the processing is stopped and the next job is started. In FIG. 8B, the next job is started at time t2, at which processing for the pattern a is completed.

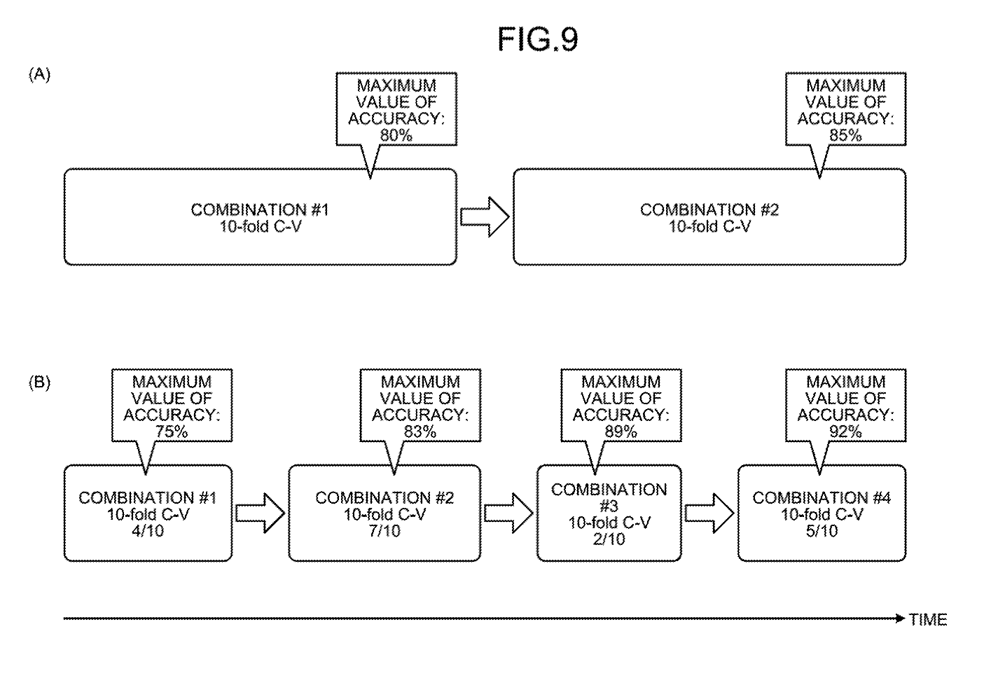

FIG. 9 are diagrams each schematically illustrating an overview of a workflow of machine learning. Description is made with reference to FIG. 9 through examples, in each of which predictive models are built with ten patterns per processing parameter combination and validated by distributed processing. FIG. 9(A) illustrates an example where predictive models have been built with ten patterns for each of the combination #1 and the combination #2 and validated by conventional distributed processing. A highest one of prediction accuracies of predictive models of the combination #1 is 80%. A highest one of prediction accuracies of predictive models of the combination #2 is 85%. In the example of FIG. 9(A), the predictive model of the combination #2 having the highest prediction accuracy of 85% is obtained as a predictive model having the highest prediction accuracy.

FIG. 9(B) illustrates an example where predictive models have been built and validated with each of the combination #1 to the combination #4 by distributed processing of the first embodiment. The job for the combination #1 is stopped at the fourth pattern of the ten patterns, and 75% is obtained as a highest prediction accuracy. The job for the combination #2 is stopped at the seventh pattern of the ten patterns, and 83% is obtained as a highest prediction accuracy. The job for the combination #3 is stopped at the second pattern of the ten patterns, and 89% is obtained as a highest prediction accuracy. The job for the combination #4 is stopped at the fifth pattern of the ten patterns, and 92% is obtained as a highest prediction accuracy. In the example of FIG. 9(B), the predictive model of the combination #4 having the highest prediction accuracy of 92% obtained as a predictive model having the highest prediction accuracy. As described above, the distributed processing system 1 according to the first embodiment increases processing efficiency of distributed processing and enables searching a large number of combinations of processing parameters, thereby increasing prediction accuracy in machine learning.

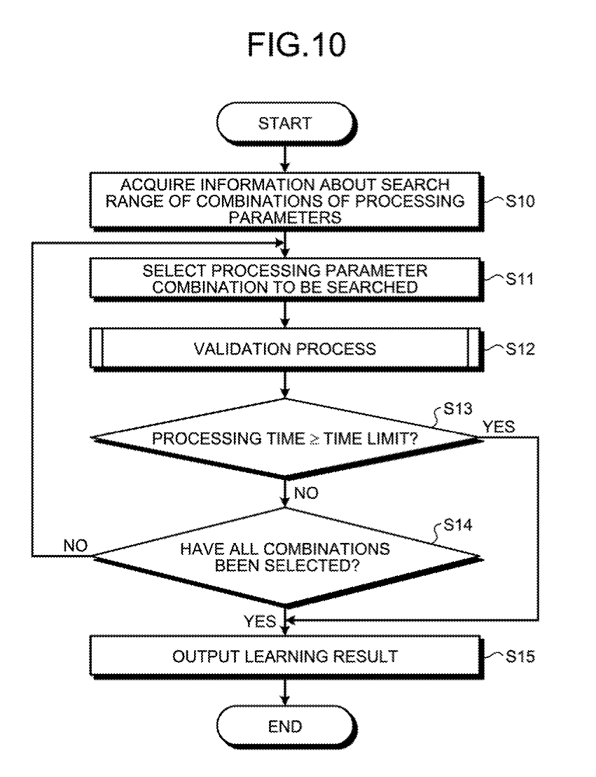

Flows of processing executed by the apparatuses of the distributed processing system 1 according to the first embodiment are described below. First, a flow of distributed processing for machine learning executed by the management server 10 is described. FIG. 10 is a flowchart illustrating an example of a procedure for distributed processing. This distributed processing is executed with a predetermined, timing, which may be, for example, at pre-specified regular intervals, at a specified time of day, or upon receiving an instruction to start processing from an operating screen (not illustrated).

As illustrated in FIG. 10, the master unit 20 acquires information about a search range of combinations of changeable various processing parameters of predictive models (S10). The master unit 20 may acquire the information about the search range of the combinations by receiving specification from a user, such as an administrator. The master unit 20 may acquire information derived from a previous learning result(s) by other software by calculation or the like as the information about the search range of the combinations.

The master unit 20 selects a not-yet-selected processing parameter combination from the specified range of the various processing parameters (S11). At this selection, the master unit 20 may put a higher priority on a combination that is expected to yield a higher prediction accuracy by making prediction using a processing result(s) of an already-processed processing parameter combination(s).

The master unit 20 performs a validation process of validating predictive models of the selected processing parameter combination (S12). The validation process will be described in detail later.

The master unit 20 determines whether or not processing time of distributed processing has reached or exceeded time limit (S13). When the processing time of distributed processing has not reached the time limit yet (No at S13), the master unit 20 determines whether or not all the combinations of the various processing parameters within the specified range have been selected (S14). When there is a combination that is not selected yet (No at S14), processing moves to S11 described above.

On the other hand, when the processing time of distributed processing has reached or exceeded the time limit (Yes at S13), the master unit 20 outputs one processing parameter combination, with which the highest prediction accuracy is obtained, of processing parameter combinations learned up to this point in time as a learning result (S15). Then processing end.

When all the combinations have been selected (Yes at (S14), processing moves to S15 described above.

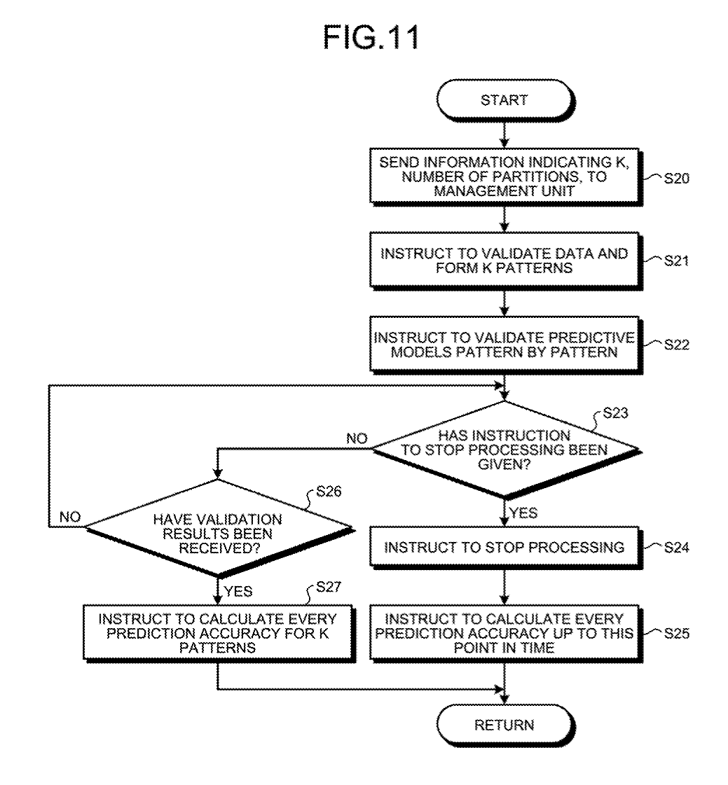

FIG. 11 is a flowchart illustrating an example of a procedure for the validation process. This validation process is executed from S12 of distributed processing, for example.

The master unit 20 sends information indicating the number of partitions K, by which data to be processed is to be divided, to the management unit 21 (S20). The master unit 20 splits the data to be processed into K parts and instructs the worker unit 30 of each of the nodes 11 to form K patterns, each made up of training data sets and a validation dataset (S21). The master unit 20 instructs the worker unit 30 of each of the nodes 11 to validate predictive models each built with a different one of the patterns (S22).

The master unit 20 determines whether or not an instruction to stop processing a job has been given from the management unit 21 (S23). When an instruction to stop processing a job has been given (Yes at S23), the master unit 20 instructs the worker unit 30 of each of the nodes 11 to stop the job that is currently being processed (S24). The master unit 20 instructs the worker unit 30 of each of the nodes 11 to calculate every prediction accuracy for the pattern(s), processing with which is completed up to this point in time (S25). Processing then moves to S13 of distributed processing.

On the other hand, when an instruction to stop processing a job has not been given (No at S23), the master unit 20 determines whether or not a validation result has been received from the worker unit 30 of each of the nodes 11 (S26). When no validation result has been received from the worker units 30 of the nodes 11 (No at S26), processing moves to S23 described above.

On the other hand, when a validation result has been received from the worker unit 30 of each of the nodes 11 (Yes at S26), the master unit 20 instructs the worker unit 30 of each of the nodes 11 to calculate every prediction accuracy for the K patterns (S27). Processing then moves to S13 of distributed processing.

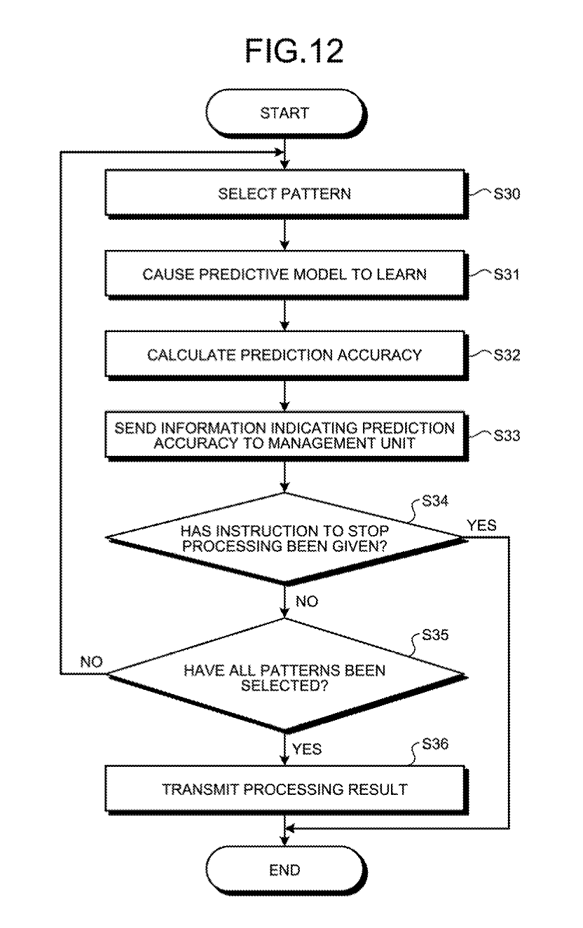

A flow of processing executed by the node 11 to validate predictive models with a selected processing parameter combination is described below. FIG. 12 is a flowchart illustrating an example of a procedure for a predictive-model validation process. This predictive-model validation process is executed with a predetermined timing, which may be, for example, when an instruction to perform predictive model validation is given from the master unit 20.

The worker unit 30 selects one not-yet-selected pattern of the K patterns, each made up of training datasets and a validation dataset (S30). The worker unit 30 causes a predictive model to learn the selected processing parameter combination using the training datasets of the selected pattern (S31). The worker unit 30 calculates a prediction accuracy of the predictive model having undergone the learning using the validation dataset of the selected pattern (S32). The worker unit 30 sends information indicating the calculated prediction accuracy to the management unit 21 (S33).

The worker unit 30 determines whether or not an instruction to stop processing has been given from the master unit 20 (S34). When an instruction to stop processing has been given from the master unit 20 (Yes at S34), processing ends.

On the other hand, when an instruction to stop processing has not been given from the master unit 20 (No at S34), the worker unit 30 determines whether or not all the K patterns have been selected (S35). When there is a pattern that is not selected yet among the K patterns (No at S35), processing moves to S30 described above.

On the other hand, when all the K patterns have been selected (Yes at 335), the worker unit 30 transmits a processing result of the validation to the master unit 20 (S36). Processing then ends. For example, the worker unit 30 transmits information indicating prediction accuracies of the respective patterns as the processing result of the validation to the master unit 20.

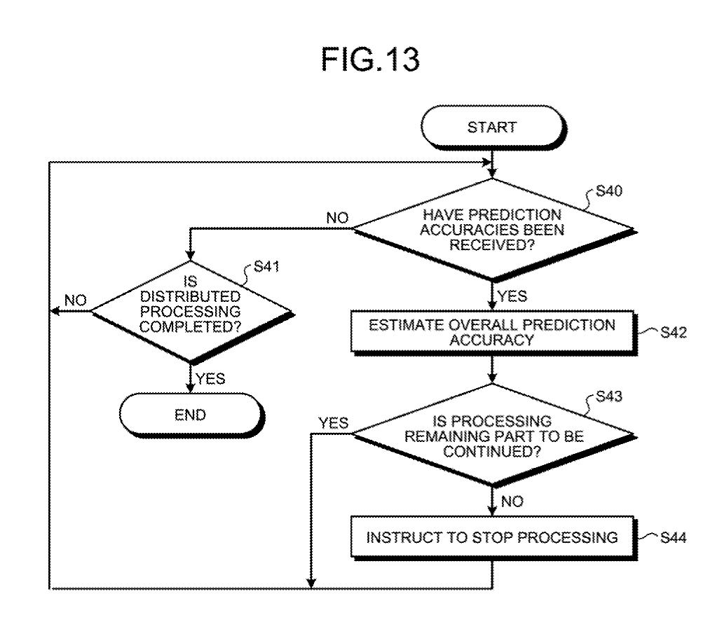

A flow of processing executed by the management server 10 to manage execution of distributed processing is described below. FIG. 13 is a flowchart illustrating an example of a procedure for a management process. This management process is executed with a predetermined timing, which may be, for example, at pre-specified regular intervals when distributed processing is executed or upon receiving the information indicating the number of partitions K, by which data to be processed is to be divided.

The collection unit 40 determines whether or not prediction accuracies have been received from the nodes 11 (S40). When prediction accuracies have not been received (No at S40), the collection unit 40 determines whether or not distributed processing is completed (S41). When distributed processing is not completed (No at S41), processing moves to S40. On the other hand, when distributed processing is completed (Yes at S41), processing ends.

When the prediction accuracies have been received (Yes at S40), the estimation unit 41 estimates prediction accuracy, which is an overall processing result of the job, for which the prediction accuracies have been received, based on the received prediction accuracies (S42).

The determination unit 42 determines whether or not to continue processing the remaining part of the job depending on the estimated prediction accuracy (S43). When the determination unit 42 determines to continue processing the remaining part of the job (Yes at S43), processing moves to S40 described above.

On the other hand, when the determination unit 42 determines not to continue processing the remaining part of the job (No at S43), the determination unit 42 sends instruction information that instructs to stop processing the job to the master unit 20 (S44). Processing then moves to S40 described above.

As described above, the management unit 21 collects, from each of the plurality of nodes 11 that process a to-be-processed job distributed among the nodes 11, a processing result of a subjob distributed to the node 11. The management unit 21 estimates, based on the collected processing results of the subjobs, an overall processing result, which is a result of overall processing corresponding to the subjobs. The management unit 21 determines whether or not to continue processing the remaining subjob(s) of the subjobs corresponding to the overall processing depending on the estimated overall processing result. As a result, the management unit 21 can increase processing efficiency of distributed processing.

Furthermore, the management unit 21 collects processing results of subjobs held by the plurality of nodes 11 or processing results of subjobs generated through a process executed across two or more of the plurality of nodes 11. Accordingly, the management unit 21 can estimate the overall processing result of the to-be-processed job from the collected processing results even when, processing of the to-be-processed job is not completed.

Furthermore, when it is estimated that predetermined performance requirement will be satisfied or that the predetermined performance requirement will not be satisfied, the management unit 21 determines that it is unnecessary to execute the remaining subjob(s) of the subjobs corresponding to the overall processing. As a result, the management unit 21 to stop processing that does not affect a final result of distributed processing significantly, thereby increasing processing efficiency of distributed processing.

Furthermore, the management unit 21 collects, from each of the plurality of nodes 11 that process the job split into subjobs distributed among the nodes 11 for each of processing parameter combinations of predictive models in machine learning, a processing result of a subjob distributed to the node 11. The management unit 21 estimates, based on the collected processing results of the subjobs, a prediction accuracy of the predictive models of the job corresponding to the subjobs. When the estimated prediction accuracy satisfies the first prediction accuracy or does not satisfy the second prediction accuracy, which is lower than the first prediction accuracy, the management unit 21 determines that it is unnecessary to execute the remaining subjob(s) of the job, for which the prediction accuracy is estimated. Accordingly, the management unit 21 can stop processing that does not affect a final result of distributed processing in machine learning significantly, thereby increasing processing efficiency of distributed processing in machine learning.

### Second Embodiment

While an embodiment of the disclosed apparatus has been described above, the present invention may be implemented in various other forms than that of the above-described embodiment. Other embodiments in accordance with the present invention are described below.

Elements of the apparatuses illustrated in the drawings are functional concepts. It is not intended that the elements be physically configured as illustrated. Specifically, specific forms of distribution/integration of the elements of the apparatuses are not limited to those illustrated in the drawings; all or a part of the elements may be functionally or physically distributed/integrated in desired units depending on various loads, usages, and the like. For example, the processing units of the management unit 21, i.e., the collection unit 40, the estimation unit 41, and the determination unit 42, may be integrated as appropriate. Furthermore, all or a desired part of processing functions to be performed by the processing units can be implemented in a CPU or in a program(s) to be parsed and executed by the CPU or, further alternatively, can be implemented in wired-logic-based hardware.

Distributed-Processing Execution-And-Management Program

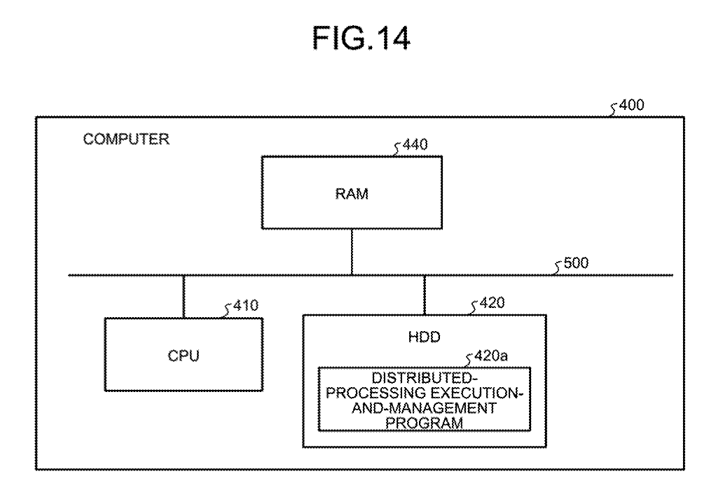

The various processing described in the embodiment described above may be implemented by executing a program prepared in advance on a computer system, such as a personal computer and a work station. An example of the computer system that executes a program providing functions similar to those of the embodiment is described below. First, a distributed-processing execution-and-management program is described first. FIG. 14 is an explanatory diagram illustrating an example architecture of a computer that executes the distributed-processing execution-and-management program.

As illustrated in FIG. 14, a computer 400 includes a CPU (Central Processing Unit) 410, an HDD (Hard Disk Drive) 420, and a RAM (Random Access Memory) 440. The computer 400, the CPU 410, the HDD 420, and the PAM 440 are connected via a bus 500.

A distributed-processing execution-and-management program 420a that exerts functions similar to those of the collection unit 40, the estimation unit 41, and the determination unit 42 described above is stored in the HDD 420 in advance. The distributed-processing execution-and-management program 420a may be split as appropriate.

The HDD 420 stores various information. For example, the HDD 420 stores OS and various data.

The CPU 410 reads out the distributed-processing execution-and-management program 420a from the HDD 420 and executes the distributed-processing execution-and-management program 420a, thereby performing operations similar to those performed by the processing units of the embodiment. Specifically, the distributed-processing execution-and-management program 420a performs operations similar to those performed by the collection unit 40, the estimation unit 4.1, and the determination unit 42.

The distributed-processing execution and-management program 420a described above is not necessarily stored in the HDD 420 in advance.

The distributed-processing execution-and-management program 420a may be stored in a “portable physical medium”, such as a flexible disk (FD), a CD-ROM, a DVD, a magneto-optical disk, and an IC card, to be inserted to the computer 400. In this case, the computer 400 may preferably read out the distributed-processing execution-and-management program 420a from the portable physical medium and executes the distributed-processing execution-and-management program 420a.

Further alternatively, the distributed-processing executionandm,anagement program 420a may be stored in “another computer (or server)” or the like connected to the computer 400 via a public line, the Internet, a LAN, a WAN, or the like. In this case, the computer 400 may preferably read out the distributed-processing execution-and-management program 420a from the computer (or server) and executes the distributed-processing execution-and-management program 420a.

According to an aspect of the present invention, processing efficiency of distributed processing can be increased.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit, and scope of the invention.

What is claimed is:

1. A non-transitory computer-readable recording medium having stored therein a control program that causes a computer to execute a process comprising:
collecting a processing result of a subjob distributed to a plurality of nodes, each of the plurality of nodes processing a to-be-processed job distributed among the nodes;
estimating an overall processing result, based on the collected processing results of the subjobs, the overall processing result being a result of overall processing corresponding to the subjobs; and
determining whether or not to continue processing remaining subjobs of the subjobs corresponding to the overall processing depending on the estimated overall processing result.

2. The non-transitory computer-readable recording medium according to claim 1, wherein the collecting collects processing results of the subjobs held by the plurality of nodes or processing results of the subjobs generated through a process executed across the plurality of nodes.

3. The non-transitory computer-readable recording medium according to claim 1, wherein the determining is performed such that when it is estimated that predetermined performance requirement will be satisfied or that the predetermined performance requirement will not be satisfied, it is determined that it is unnecessary to execute the remaining subjobs of the subjobs corresponding to the overall processing.

4. The computer-readable recording medium according to claim 1, wherein
the collecting is performed by collecting, from each of the plurality of nodes that process the job split into subjobs distributed among the nodes for each of processing parameter combinations of predictive models in machine learning, a processing result of the subjob distributed to the node,
the estimating is performed by estimating, based on the collected processing results of the subjobs, a prediction accuracy of the predictive models of the job corresponding to the subjobs, and
the determining is performed such that when the estimated prediction accuracy satisfies first prediction accuracy or does not satisfy second prediction accuracy that is lower than the first prediction accuracy, it is determined that it is unnecessary to execute remaining subjobs of the job, for which the prediction accuracy is estimated.

5. A computer-executable method for executing and managing distributed processing, the method comprising:
collecting, by a processor, a processing result of a subjob distributed to a plurality of nodes, each of the plurality of nodes processing a to-be-processed job distributed among the nodes;
estimating, by the processor, an overall processing result, based on the collected processing results of the subjobs, the overall processing result being a result of overall processing corresponding to the subjobs; and
determining, by the processor, whether or not to continue processing remaining subjobs of the subjobs corresponding to the overall processing depending on the estimated overall processing result.

6. A control apparatus comprising: a processor that executes a process including:
collecting a processing result of a subjob distributed to a plurality of nodes, each of the plurality of nodes processing a to-be-processed job distributed among the nodes;
estimating an overall processing result, based on the collected processing results of the subjobs, the overall processing result being a result of overall processing corresponding to the subjobs; and
determining whether or not to continue processing remaining subjobs of the subjobs corresponding to the overall processing depending on the estimated overall processing result.
